(19) United States
(12) Patent Application Publication
(10) Pub. No.: US 2008/0058143 A1
(43) Pub. Date: Mar. 6, 2008

(54) AUTOTENSIONER

(75) Inventor: Koji Fukuda, Kobe-shi (JP)

Correspondence Address: ROBERTS, MLOTKOWSKI & HOBBES, P. O. BOX 10064, MCLEAN, VA, 22102-8064, US

(73) Assignee: BANDO CHEMICAL INDUSTRIES, LTD., Kobe-shi (JP)

(21) Appl. No.: 11/846,174

(22) Filed: Aug. 28, 2007

(30) Foreign Application Priority Data
Aug. 29, 2006 (JP) 2006-231724

(51) Int. Cl. F16H 7/12

(52) U.S. Cl. 474/138

(57) ABSTRACT

In an autotensioner of a type in which a boss of an oscillating member is pivotally fitted on a spindle of a stationary member through a bush including a metal part and a resin layer formed on the inner periphery of the metal part, the clearance in its initially assembled state between the outer periphery of the spindle and the inner periphery of the bush is 60 μm or less to make it difficult to cause fretting between the spindle and the bush even upon input of large short quick vibrations to the autotensioner and thereby extend the service life of the autotensioner. Furthermore, the spindle has a surface hardness of Hv 500 or more to prevent wear of the spindle itself from progressing even upon occurrence of fretting.

### CROSS-REFERENCE TO RELATED APPLICATION

This application claims priority under 35 USC 119 to Japanese Patent Application No. 2006-231724 filed on Aug. 29, 2006, the entire contents of which are incorporated herein by reference.

### BACKGROUND OF THE INVENTION

(a) Field of the Invention

This invention relates to autotensioners and particularly relates to the technique for preventing the shortening of their service life due to fretting.

(b) Description of the Related Art

An autotensioner is conventionally known which is used, for example, in a belt accessory drive system for a vehicle engine, applies tension to a belt and damps the action of applying the tension, thereby preventing bouncing (fluttering) of the belt and providing stable torque transmission.

Specifically, as disclosed in Published Japanese Patent Application No. H03-20146, such an autotensioner includes a stationary member fixedly mounted, for example, to an engine, a movable part, such as an arm, fitted at a boss thereof on and pivotally supported to a spindle (shaft) of the stationary member and having a tension pulley rotatably supported to an end thereof, a torsion coil spring carried about the boss of the movable part and anchored at one end to the stationary member and at the other end to the movable part to urge the movable part into pivotal movement relative to the stationary member in a direction for the tension pulley to push the belt by its torsion torque, and a damper for damping angular oscillation of the movable part.

In such an autotensioner, a dry type metal bush (made as of sintered copper material) is press fitted in the boss of the movable part to lie between the boss and the spindle outer periphery of the stationary member, whereby the movable part can smoothly oscillate (pivotally move) without feeding oil to the clearance between the movable part and the stationary member.

However, when the above autotensioner is used, for example, in a diesel engine accessory drive system mounted on a midsize or large size vehicle (of 10 or more deadweight ton), such as a truck, short quick vibrations of the engine itself are significantly large and continuously input to the autotensioner. Therefore, in addition to normal oscillation of the movable part about the spindle, the spindle largely vibrates in a direction orthogonal to its axis to cause percussive wear, i.e., fretting, between the spindle and the bush. The fretting incurs the exposure of metal of the bush at the surface to bring it into contact with metal of the spindle, whereby the spindle outer periphery is scraped and worn and in turn the clearance between the spindle outer periphery and the bush (boss inner periphery) increases from its initial value. This clearance increase further accelerates the wear due to fretting and incurs a significant shortening of the service life of the autotensioner. Therefore, the autotensioner cannot satisfy its durability required for the midsize or large size vehicle.

With the foregoing in mind, an object of the present invention is to appropriately set the relation between the spindle and the bush in the autotensioner, thereby making it difficult for the autotensioner to cause fretting between the spindle and the bush even upon input of large short quick vibrations and in turn extending the service life of the autotensioner.

### SUMMARY OF THE INVENTION

To attain the above object, according to the present invention, the initial clearance between the spindle outer periphery and the bush inner periphery is set at a value at which the autotensioner becomes less likely to cause wear due to fretting.

Specifically, a first aspect of the present invention is directed to an autotensioner including: a stationary member including a spindle; a movable part including a boss pivotally fitted on the spindle and a pulley rotatably carried at a position offset from the axis of pivotal movement of the boss and capable of contact with a belt; a torsion coil spring urging the movable part into pivotal movement relative to the stationary member in a direction for the pulley to push the belt; and a damper for damping angular oscillation of the movable part.

Furthermore, the boss has a bush press-fitted therein and is rotatably fitted through the bush on the spindle, the bush includes a metal part and a resin layer formed on the inner periphery of the metal part, and the autotensioner has a clearance of 60 μm or less between the outer periphery of the spindle and the inner periphery of the bush in an initial state where the autotensioner is assembled by fitting the boss through the bush on the spindle.

With this configuration, the clearance between the spindle outer periphery and the bush inner periphery in an initial state where the autotensioner is assembled by fitting the boss of the movable part through the bush on the spindle is 60 μm or less. This very small clearance makes it difficult for the autotensioner to cause percussive wear or fretting between the spindle and the bush even if large short quick vibrations are input to the autotensioner. Therefore, the service life of the autotensioner can be extended.

If the clearance between the spindle outer periphery and the bush inner periphery in the initial state is larger than 60 μm, the effect of preventing fretting becomes low. Therefore, the clearance is set at 60 μm or smaller.

In a second aspect of the present invention, the spindle surface has a Vickers hardness of Hv 500 or more. Since, as described above, the initial clearance between the spindle outer periphery and the bush inner periphery is 60 μm or less, this makes it difficult for the autotensioner to cause wear due to fretting. In addition, since the spindle outer periphery has a high surface hardness of Hv 500 or more, fretting, if at all, will be less likely to develop the wear of the spindle itself. Thus, the service life of the autotensioner can be effectively extended. If the surface hardness of the spindle is less than Hv 500, the above effect cannot be effectively obtained.

In a third aspect of the present invention, the spindle of the autotensioner is made of stainless steel and has a nitrided layer formed on the surface. Thus, the spindle can have a surface hardness of Hv 500 or more without surface treatment using any environmentally toxic substance, such as sexivalent chrome.

In a fourth aspect of the present invention, the autotensioner is provided in an accessory drive system for driving accessories of a diesel engine for a midsize or large size vehicle. This provides an autotensioner optimal for applications requiring a long service life.

### BRIEF DESCRIPTION OF THE DRAWINGS

FIG. 1 is a cross-sectional view of an autotensioner according to an embodiment of the present invention.

FIG. 2 is an exploded cross-sectional view of the autotensioner.

FIG. 3 is a graph showing the results of a test on the wear property of a bush.

FIG. 4 is a graph showing the results of a test on the wear property of a spindle.

### DETAILED DESCRIPTION OF THE INVENTION

The best mode of the present invention will be described below in detail with reference to the drawings. The following description of the preferred embodiment is merely illustrative in nature and is not intended to limit the scope, applications and use of the invention.

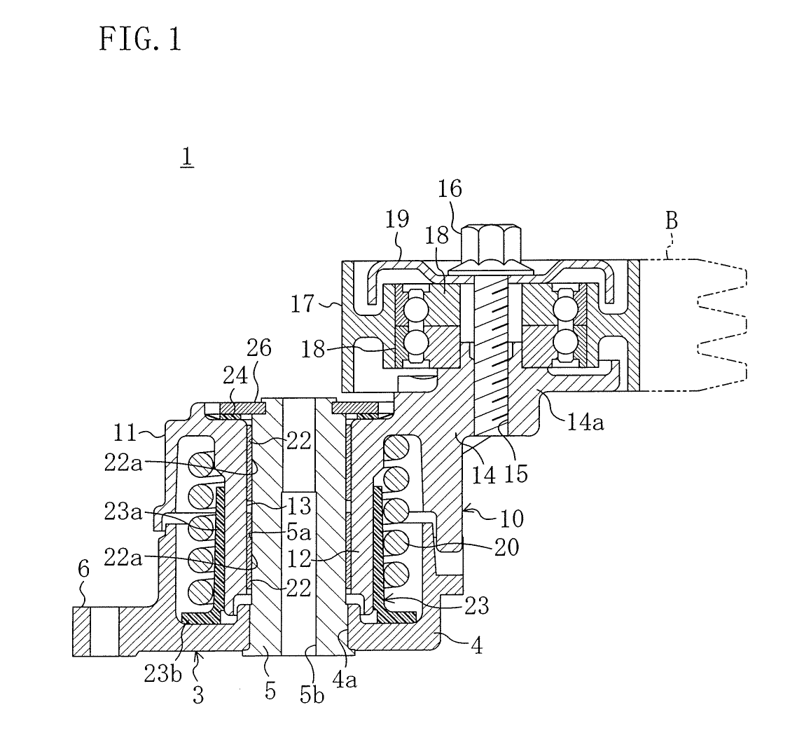

In FIG. 1, reference numeral 1 denotes an autotensioner according to an embodiment of the present invention. The autotensioner 1 is used in a belt drive system, such as a diesel engine accessory drive system (not shown) mounted on a midsize or large size vehicle (of 10 or more deadweight ton), such as a truck.

The accessory drive system, although not shown, includes a crank pulley formed of a V-ribbed pulley carried on, for example, the crank shaft of a vehicle-mounted engine, a compressor pulley formed of a V-ribbed pulley carried on the rotational shaft of a compressor (accessory) for an air conditioner, a PS pump pulley formed of a V-ribbed pulley carried on the rotational shaft of a power steering pump (accessory), an alternator pulley formed of a V-ribbed pulley carried on the rotational shaft of an alternator (accessory), an idler pulley formed of a V-ribbed pulley, and a fan pulley formed of a flat pulley for driving a cooling fan into rotation. A drive belt B formed of a V-ribbed belt (shown in the imaginary line in FIG. 1) is wrapped around these pulleys in a so-called serpentine layout, namely, wrapped around the V-ribbed pulleys in a normally bent position where its bottom face is in contact therewith and wrapped around the fan pulley formed of a flat pulley in an oppositely bent position where its back face is in contact therewith. The accessory drive system drives each accessory by using engine rotation to cause the belt B to travel among the pulleys.

The autotensioner 1 is of arm type and disposed at a slack-side span of the belt B coming from the crank pulley. The autotensioner 1 automatically adjust the belt tension by pushing the slack-side span from the belt back face side.

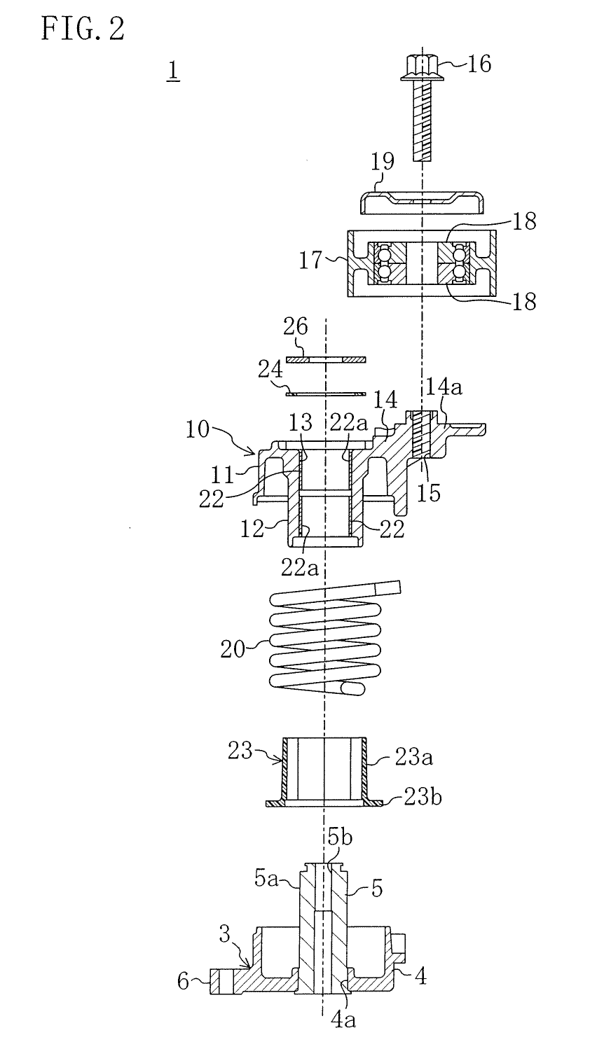

As also shown in FIG. 2, the autotensioner 1 includes a stationary member 3 to be fixedly mounted on the engine, an oscillating member 10 serving as a movable part pivotally supported to the stationary member 3, a tension pulley 17 formed of a flat pulley and rotatably carried at a position of the oscillating member 10 offset from the pivot axis thereof (at an end of the later-described arm 14) to push the belt B in an oppositely bent position, a torsion coil spring 20 urging the oscillating member 10 into pivotal movement in a direction for the tension pulley 17 to push the belt B by torsion torque, and three types of dampers for damping angular oscillation of the oscillating member 10.

The stationary member 3 includes a stationary member body 4 in the shape of a bottomed cylinder (cup) having an opening at one end (at the top in FIGS. 1 and 2) and made as of an aluminum alloy, and a spindle 5 (shaft) coaxial with the stationary member body 4, integrally standing from the bottom of the stationary member body 4 and having a distal end extending beyond the opening of the stationary member body 4. The spindle 5 has a shape of a hollow cylinder having a central bore 5b of small diameter and is press fitted in a fitting hole 4a formed through the center of the bottom wall of the stationary member body 4 and thereby integrally fixed to the stationary member body 4. The outer periphery of the stationary member body 4 has a plurality of mounting brackets 6, 6, . . . extending from its bottom. The stationary member 3 is fixedly mounted at each of the mounting brackets 6, 6, . . . on the engine by unshown mounting bolts.

Furthermore, although not shown, the side wall of the stationary member body 4 has a spring anchoring part formed of a cutaway cut from the opening side or a through hole.

The oscillating member 10, like the stationary member body 4, is made of metal such as an aluminum alloy and includes an oscillating member body 11 in the shape of a bottomed cylinder having an opening at one end (at the bottom in FIGS. 1 and 2). The oscillating member body 11 is formed to have substantially the same outer diameter as the stationary member body 4. The side wall of the oscillating member body 11 has a spring anchoring part (not shown) formed of a cutaway cut from the opening side or a through hole.

The oscillating member body 11 has a cylindrical boss 12 formed integrally and coaxially therewith to extend from its inner bottom beyond its opening. The boss 12 has a boss hole 13 internally formed through the bottom wall of the oscillating member body 11. The boss 12 is fitted from its distal end side on the spindle 5 of the stationary member 3. Thus, the oscillating member 10 is supported at the boss 12 through the later-described bushes 22 and 22 to the spindle 5 of the stationary member 3 to be oscillatable (angularly movable) about it and the stationary member body 4 and the oscillating member body 11 form a substantially closed cylindrical shape with their openings opposed to each other.

The outer periphery of the oscillating member body 11 has an arm 14 integrally formed at its bottom wall side to extend radially outwardly and having an end 14a extending oppositely to the stationary member 3 (upwardly in FIGS. 1 and 2) beyond the bottom of the oscillating member body 11. The end 14a of the arm 14 has a threaded hole 15 formed through the arm 14 in parallel with the axis of the boss 12. A mounting bolt 16 serving as a pulley shaft is screwed in the threaded hole 15 from the opposite side to the stationary member 3 (from above in FIG. 1) and tightened. The tension pulley 17 is rotatably mounted and supported through two bearings 18 and 18 to the end 14a of the arm 14 by the bolt 16. In other words, the tension pulley 17 is supported at the position of the mounting bolt 16 offset from the axis of the boss 12. In FIGS. 1 and 2, reference numeral 19 denotes a disc-shaped dust shield covering the paired bearings 18 and 18 from one axial side and serving also as a washer. The dust shield is attached to the arm end 14a, together with the bearings 18 and 18, by the mounting bolt 16.

The torsion coil spring 20 is disposed around the boss 12 of the oscillating member 10 with both ends (tongues) extending radially outwardly. One of the ends is anchored in the spring anchoring part of the stationary member body 4, while the other end is anchored in the spring anchoring part of the oscillating member body 11. Furthermore, the torsion coil spring 20 is interposed in an axially compressed state between the stationary member body 4 and the oscillating member body 11 and urges the oscillating member 10 into angular movement in a direction for the tension pulley 17 to push the belt B by torsion torque in a direction of expansion of the coil diameter of the torsion coil spring 20.

Next, a description is given of the three types of dampers for damping angular oscillation of the oscillating member 10. First, two cylindrical metal bushes 22 and 22 are interposed between the spindle 5 of the stationary member 3 and the boss 12 of the oscillating member 10. The two metal bushes 22 and 22 are press fitted in the boss hole 13 through the openings at both ends of the boss hole 13 to leave a slight space between both the bushes 22 and 22 and thereby fixed to the boss 12 against rotation. Each bush 22 is obtained by forming a resin layer for lubrication on the inner periphery of a thin metal cylinder made as of a sintered copper material and configured, when fitted on the spindle 5, to transfer resin of the resin layer on its inner periphery to the outer periphery of the spindle 5, thereby dry lubricating the interface between the spindle 5 and the boss 12 of the oscillating member 10 (or bush 22) without supply of any lubricating oil and concurrently damping angular oscillation of the oscillating member 10.

Secondly, a resin-made spring support 23 serving as a second damper is disposed around the boss 12 of the oscillating member 10. The spring support 23 includes a substantially cylindrical sliding part 23a disposed between the boss 12 and the torsion coil spring 20 and pressed against the outer periphery of the boss 12 by the reaction force of torsion torque of the torsion coil spring 20, and a flange 23b extending radially outwardly from an end of the sliding part 23a close to the distal end of the boss 12 and axially pressed against and secured to the inner bottom surface of the stationary member body 4 by the torsion coil spring 20. Thus, the torsion coil spring 20 presses the sliding part 23a of the spring support 23 against the outer periphery of the boss 12 of the oscillating member 10 and the sliding part 23a in turn presses the boss 12 against the bushes 22 and 22, whereby the spring support 23 damps angular oscillation of the oscillating member 10.

Furthermore, the distal end of the spindle 5 of the stationary member 3 extends through the boss hole 13 of the boss 12 (the bottom wall of the oscillating member body 11) beyond the outside surface of the oscillating member body 11. A disc-shaped metal plate member 26 for preventing the oscillating member 10 from falling out is fixedly secured to the extended part of the spindle 5 against rotation as by swaging. A resin thrust washer 24 of small diameter serving as a third damper is clamped between the plate member 26 and the outside surface of the oscillating member body 11 (the end surface of the boss 12). The thrust washer 24 damps angular oscillation of the oscillating member 10 by sliding on the outside surface of the oscillating member body 11.

In an initial state where the autotensioner 1 having the above structure is assembled by fitting the boss 12 through the bushes 22 and 22 onto the spindle 5, the clearance between the outer periphery 5a of the spindle 5 and the inner periphery 22a of each bush 22 is set at 60 μm or less. The reason for this is that if the initial clearance between the outer periphery 5a of the spindle 5 and the inner periphery 22a of each bush 22 is larger than 60 μm, the effect of preventing fretting becomes low. In addition, if the clearance is at a minus value, the oscillating member 10 falls into a locking state where its pivotal movement is disabled. Therefore, the clearance is set at 0 or more even under environmental temperature conditions (e.g., −40° C. to 120° C.) where the autotensioner 1 is normally used. Furthermore, the adjustment of the clearance can be implemented by reducing variations in dimensional accuracy of the bush 22.

The spindle 5 is made of stainless steel and has the outer periphery 5a nitrided by nitrogen gas to form a nitrided layer, whereby the outer periphery 5a of the spindle 5 has a Vickers surface hardness of Hv 500 or more. If the surface hardness of the spindle 5 is lower than Hv 500, this cannot effectively provide the later-described effect of preventing wear of the spindle 5 from progressing.

Therefore, according to this embodiment, when the accessories (compressor for an air conditioner, power steering pump, alternator and fan) are driven via the belt B by the accessory drive system during operation of the diesel engine, the torsion coil spring 20 of the autotensioner 1 urges the oscillating member 10 into pivotal movement, this urging force causes the tension pulley 17 at the end of the arm 14 to push the span of the drive belt B and tension is thus applied to the belt B.

Furthermore, when variations in tension of the belt B cause the arm 14 of the oscillating member 10 to oscillate (vibrate) about the spindle 5 of the stationary member 3 together with the tension pulley 17, the angular oscillation is braked and damped by sliding resistance of the three types of dampers, namely, the metal bushes 22 and 22, the spring support 23 and the thrust washer 24, thereby automatically adjusting the tension of the belt B.

Furthermore, the autotensioner 1 has a clearance of 60 μm or less between the outer periphery 5a of the spindle 5 and the inner periphery 22a of each bush 22 in the initial state where the boss 12 of the oscillating member 10 is fitted through the bushes 22 and 22 onto the spindle 5. This very small clearance makes it difficult for the autotensioner 1 to cause percussive wear or fretting between the spindle 5 and each bush 22 even if large short quick vibrations in a direction orthogonal to the axis of the spindle 5 owing to vibrations of the operating diesel engine are input to the stationary member 3. Therefore, the service life of the autotensioner 1 can be extended.

Furthermore, since the outer periphery 5a of the spindle 5 has a high surface hardness of Hv 500 or more, fretting, if at all, will be less likely to develop the wear of the spindle 5 itself. Thus, the service life of the autotensioner 1 can be further effectively extended.

Furthermore, since the spindle 5 is made of stainless steel and has its outer periphery 5a nitrided to have a surface hardness of Hv 500 or more, the later-described effect is obtained. Specifically, increasing the surface hardness of the spindle 5 to Hv 500 or more can be implemented by, apart from nitridation of stainless steel, subjecting S45C steel (carbon steel for machine structural use) to hard chrome plating or induction hardening. However, hard chrome plating involves using environmentally toxic sexivalent chrome, which inevitably incurs an environmental problem. Therefore, this method is impractical. On the other hand, simply induction hardening a raw material of S45C steel cannot avoid rust production and, therefore, involves rust proofing it by forming a coating of manganese phosphate on the surface after induction hardening. However, the rust proofing not only roughens the surface but also invites the peeling of the manganese phosphate coating into abrasive particles. The abrasive particles might grind the raw material.

In contrast to the above alternatives, according to this embodiment in which the stainless steel is nitrided, the above problems can be avoided: the surface hardness of the spindle 5 can be Hv 500 or more without using any environmentally toxic substance and inviting the peeling of the surface coating.

### Other Embodiments

Although in the above embodiment the present invention is applied to an autotensioner provided in an accessory drive system for driving accessories of a diesel engine for a midsize or large size vehicle, it is also applicable to autotensioners of belt drive systems provided for other types of engines.

Although in the above embodiment the present invention is applied to an arm type autotensioner 1, it is needless to say that the present invention is applicable to other types of autotensioners.

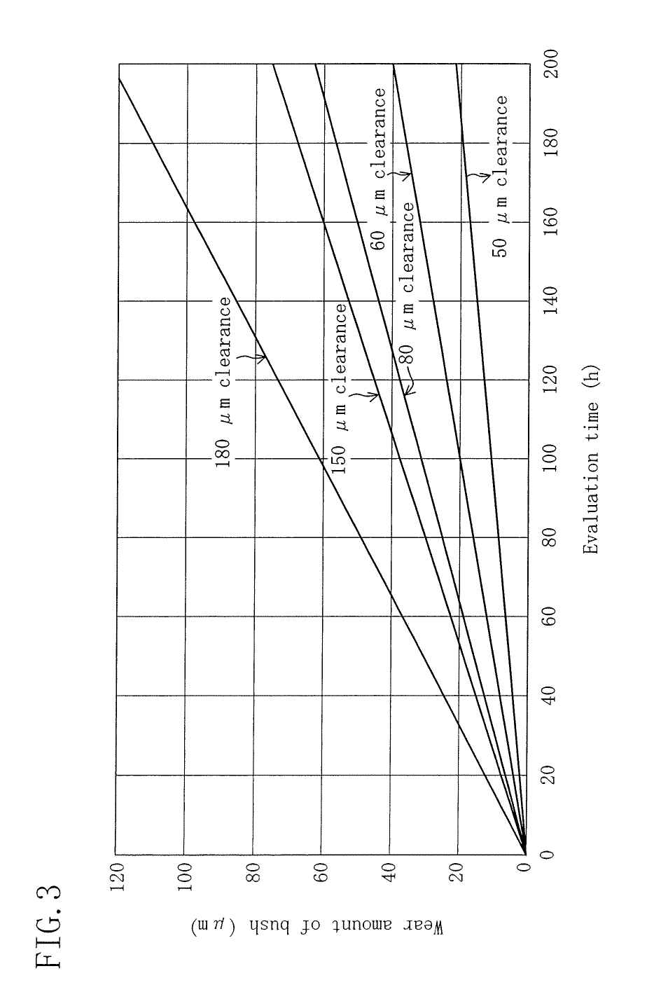

Next, a description is given of working examples of the above embodiment and comparative examples. These examples of an autotensioner 1 having the same structure as in the above embodiment were subjected to an accelerated test in order to measure in a short period of time the wear amount of the bush 22 fitted in the boss 12 of the oscillating member 10. The examples were set so that their conditions at an evaluation time after 200 hours run correspond to the conditions of a midsize or large size truck which mounts a diesel engine using an autotensioner in an accessory drive system and ran 100000 km. The examples had different clearances between the outer periphery 5a of the spindle 5 and the inner periphery of the bush 22 in an initial state where the boss 12 was fitted through the bushes 22 and 22 on the spindle 5, i.e., five different clearances of 50 μm, 60 μm, 80 μm, 110 μm and 184 μm. These five examples were measured in terms of wear amount of the bush at some evaluation times until 200 hours run. The measurement results are shown in FIG. 3.

FIG. 3 shows that when the initial clearance was larger than 60 μm, the wear amount of bush after 200 hours run exceeded 50 μm, which presents a problem in practical use and that when the initial clearance was 60 μm or less, the wear amount of bush after 200 hours run was 50 μm or less (satisfying the requirement of 60 μm or less). Therefore, even after a truck runs 100000 km, the wear amount of the bush 22 is very small, which can accomplish the object of extending the service life of the autotensioner.

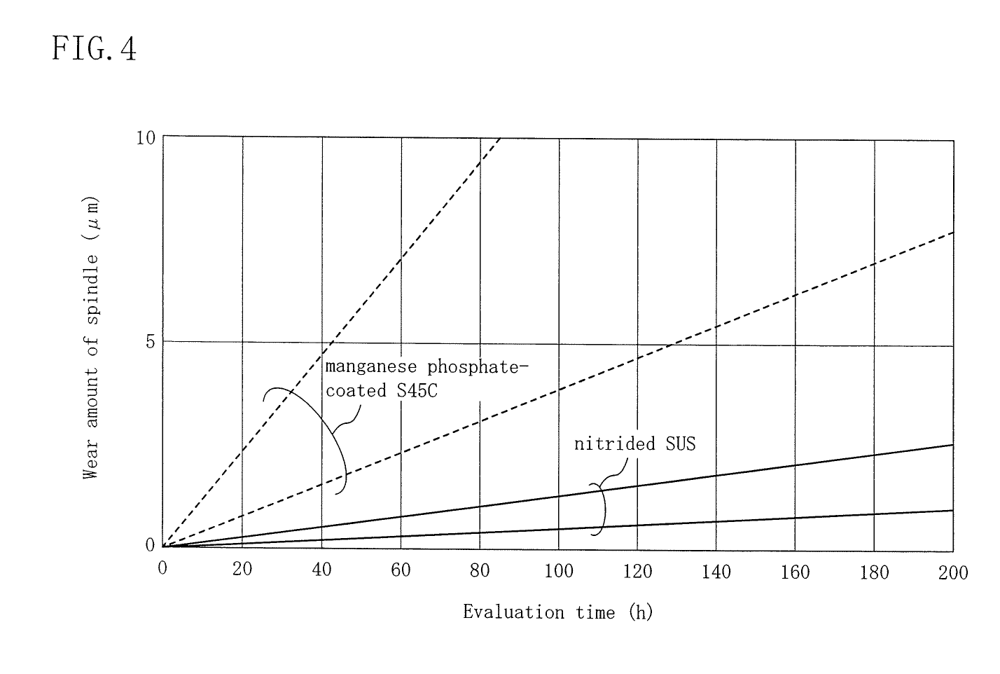

Furthermore, two autotensioners having a stainless steel spindle 5 whose surface was nitrided was prepared as inventive examples and two autotensioners having a S45C steel spindle coated with manganese phosphate coating was prepared as comparative examples. The spindles of the comparative examples have surface hardnesses of Hv 180 to Hv 230, while the spindles 5 of the inventive examples have surface hardnesses of Hv 500 to Hv 800. Each of the inventive and comparative examples was subjected to the same accelerated test as described above and measured in terms of the wear amount of the spindle. The results obtained are shown in FIG. 4. The examples had the same initial clearance of 100 μm.

FIG. 4 shows that the comparative examples exhibited wear amounts of approximately 8.0 μm or more after 200 hours run while the inventive examples exhibited wear amounts within the range of 2.66 to 0.93 μm. Therefore, according to the inventive examples, the wear amount of the spindle 5 can be kept small.

1. An autotensioner comprising:
a stationary member including a spindle;
a movable part including a boss pivotally fitted on the spindle and a pulley rotatably carried at a position offset from the axis of pivotal movement of the boss and capable of contact with a belt;
a torsion coil spring urging the movable part into pivotal movement relative to the stationary member in a direction for the pulley to push the belt; and
a damper for damping angular oscillation of the movable part,
the boss having a bush press-fitted therein and being rotatably fitted through the bush on the spindle, the bush comprising a metal part and a resin layer formed on the inner periphery of the metal part,
the autotensioner having a clearance of 60 μm or less between the outer periphery of the spindle and the inner periphery of the bush in an initial state where the autotensioner is assembled by fitting the boss through the bush on the spindle.

2. The autotensioner of claim 1, wherein the spindle has a surface hardness of Hv 500 or more.

3. The autotensioner of claim 2, wherein the spindle is made of stainless steel and has a nitrided layer formed on the surface.

4. The autotensioner of claim 1, provided in an accessory drive system for driving accessories of a diesel engine for a midsize or large size vehicle.
